(19) United States
(12) Patent Application Publication
(10) Pub. No.: US 2014/0153951 A1
(43) Pub. Date: Jun. 5, 2014

(54) FIXING APPARATUS AND IMAGE FORMING APPARATUS HAVING THE FIXING APPARATUS

(71) Applicants: TOSHIBA TEC KABUSHIKI KAISHA, Tokyo (JP); KABUSHIKI KAISHA TOSHIBA, Tokyo (JP)

(72) Inventors: Shoko SHIMMURA, Kanagawa (JP); Hiroshi KATAKURA, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/096,426

(22) Filed: Dec. 4, 2013

(30) Foreign Application Priority Data
Dec. 4, 2012 (JP) 2012-265279

(51) Int. Cl. G03G 15/20

(52) U.S. Cl. CPC G03G 15/2039
USPC 399/69

(57) ABSTRACT

A fixing apparatus includes a heating unit configured to heat a sheet having a layer of decolorizable toner applied thereon, a pressing unit configured to press the sheet towards the heating unit, and a control unit. The heating unit includes a roll member, an elastic layer formed on an outer periphery of the roll member, and a heat generating unit. The control unit is configured to control the heat generating unit, such that a first temperature at a portion of a first surface of the decolorizable toner layer contacting the heating unit is lower than a first predetermined temperature at which the decolorizable toner is decolorized, and a second temperature at a portion of the second surface of the decolorizable toner layer opposite to the first surface is higher than a second predetermined temperature at which the decolorizable toner is fixed onto the sheet.

### CROSS-REFERENCE TO RELATED APPLICATION

This application is based upon and claims the benefit of priority from Japanese Patent Application No. 2012-265279, filed Dec. 4, 2012, the entire contents of which are incorporated herein by reference.

### FIELD

Embodiments described herein relate to a fixing apparatus and an image forming apparatus including the same.

### BACKGROUND

Recently, an image forming apparatus that forms an image on a recording medium with decolorizable toner has been developed such that the recording medium can be reused after the image is erased. The decolorizable toner contains a color material that is decolorized when it is heated to a certain decolorizing temperature. Thus, the decolorizable toner containing such a color material must be fixed on a recording medium at a temperate lower than the decolorizing temperature. On the other hand, in order to ensure that the toner is sufficiently heat-resistant, the glass transition temperature of resin included in the toner needs to be above, for example, 45 degrees centigrade. However, the glass transition temperature needs to be lower for reliably fixing the toner on a recording medium.

Generally, a layer of decolorizable toner transferred on a recording medium has a certain thickness, so temperature gradient is formed in the layer when the layer of the decolorizable toner is heated. Specifically, the temperature at a bottom surface of the toner layer that is in contact with a recording medium may be lower than the temperature at a top surface of the toner layer that is in contact with a heating member. Thus, the temperature of the heating member should be maintained in a certain range in order to reliably fix the decolorizable toner on a recording medium without decolorizing the decolorizable toner.

### BRIEF DESCRIPTION OF THE DRAWINGS

FIG. 1 is a cross-sectional view illustrating the whole structure of a multi-functional peripheral as an image forming apparatus according to an embodiment.

FIG. 2 is a cross-sectional view illustrating the structure of an image forming unit of the image forming apparatus according to the embodiment.

FIG. 3 is a graph showing a relationship between a fixing rate of toner and a temperature.

FIG. 4 is a graph showing a relationship between a temperature and a color concentration of a coloring agent.

FIG. 5 is a diagram illustrating a structure of a fixing apparatus according to a first embodiment.

FIG. 6 is a graph showing a range of temperature of a heating roller at a starting point of a nip at which toner is fixable without decolorizing based on a simulation when the thickness of a rubber layer having a thermal conductivity of 0.2 W/mC is changed.

FIG. 7 is a graph showing a range of temperature of a heating roller at a starting point of a nip at which toner is fixable without decolorizing based on a simulation when the thickness of a rubber layer having a thermal conductivity of 0.6 W/mC is changed.

FIG. 8 is a graph showing a range of temperature of a heating roller at a starting point of a nip at which toner is fixable without decolorizing based on an experiment when the thickness of a rubber layer having a thermal conductivity of 0.2 W/mC is changed.

FIG. 9 is a graph showing a relationship between temperature changes with respect to thickness of the rubber layer.

FIG. 10 is a diagram illustrating a structure of a fixing apparatus according to a second embodiment.

### DETAILED DESCRIPTION

According to an embodiment, a fixing apparatus includes a heating unit configured to heat a sheet having a layer of decolorizable toner applied thereon, a pressing unit configured to press the sheet towards the heating unit, and a control unit. The heating unit includes a roll member, an elastic layer formed on an outer periphery of the roll member, and a heat generating unit. The control unit is configured to control the heat generating unit, such that a first temperature at a portion of a first surface of the decolorizable toner layer contacting the heating unit is lower than a first predetermined temperature at which the decolorizable toner is decolorized, and a second temperature at a portion of the second surface of the decolorizable toner layer opposite to the first surface is higher than a second predetermined temperature at which the decolorizable toner is fixed onto the sheet.

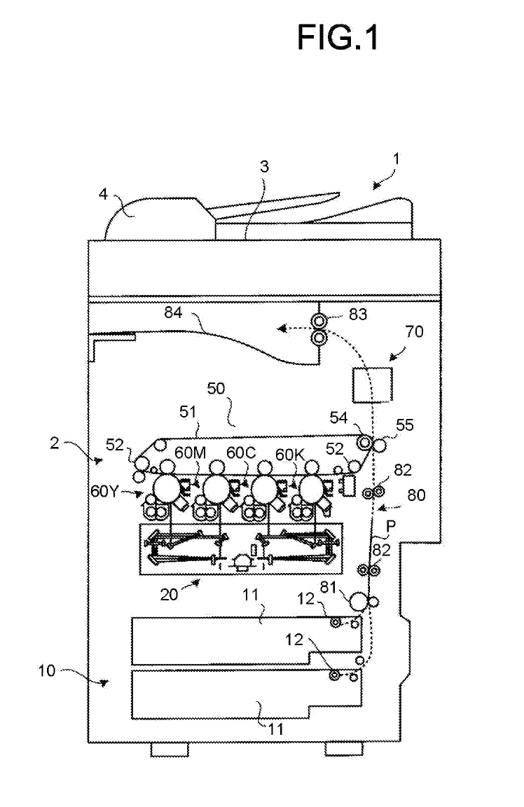

Embodiments of the present invention are described below with reference to accompanying drawings. FIG. 1 is a longitudinal section view illustrating a color multi-functional peripheral (MFP: Multi Functional Peripheral) 1 serving as an image forming apparatus. The MFP 1 comprises a printer section 2, a scanner section 3, and an original carrying section, and the like. Further, the image forming apparatus may also be an image forming single printer provided with no scanner, and is not limited to be an MFP.

The printer section 2 comprises a paper feeding section 10, a laser optical unit 20, an image forming section 50, a fixing apparatus 70 also having an erasing function which will be described in detail below, and a conveyance section 80.

The paper feeding section 10 includes a plurality of paper cassettes 11 for housing sheets as recording media and a pickup roller 12 for feeding a sheet positioned at the top of the stacked sheets in the paper cassette 11 to the image forming section 50.

The image forming section 50 comprises four image forming units 60 Y, 60M, 60C and 60K, respectively corresponding a color of Y (yellow), M (magenta), C (cyan), and K (black), an intermediate transfer belt 51 for transferring an decolorizable toner images formed by the image forming units 60 Y, 60M, 60C, and 60K, a plurality of rollers 52 for applying predetermined tension on the intermediate transfer belt 51 and a drive roller 54 for driving the intermediate transfer belt 51. Further, the image forming section 50 comprises a transfer roller 55 serving as a transfer device. One part of the intermediate transfer belt 51 is disposed between the drive roller 54 and the transfer roller 55. Further, decolorizable toner is simply expressed as toner if not specifically mentioned.

The conveyance section 80 comprises a register roller 81 for starting conveying the recording medium P picked up by the pickup roller 12 to the image forming section 50 at a given timing and a plurality of conveyance rollers 82 for conveying the recording medium P conveyed by the register roller 81. Further, the conveyance section 80 is provided with a paper discharging roller at a position where the recording medium p is directly discharged to the outside of the printer section 2, and a paper discharging tray 84 which is arranged on the upper portion of the printer section 2 to receive the recording medium P discharged by the paper discharging roller 83.

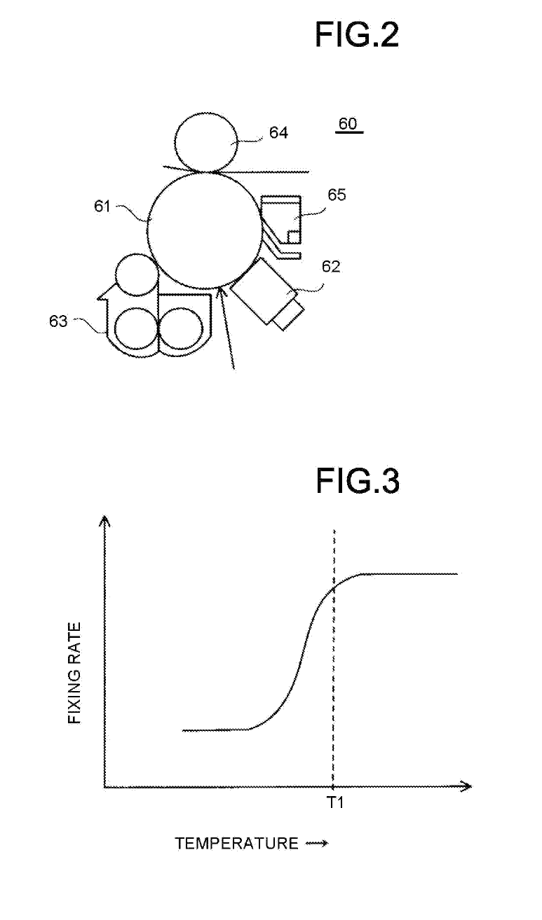

FIG. 2 shows an enlarged view of the image forming unit 60 for a further description. The image forming unit 60 comprises a photoconductor 61 irradiated with light emitted from the laser optical section 20, a charger 62 for uniformly charging the surface of the photoconductor 61, a developing device 63 which stores toner therein and supplies the toner to the photoconductor 61, an intermediate transfer roller 64 for transferring the toner supplied to the photoconductor 61 onto the intermediate transfer belt 51, and a cleaning unit 65 for cleaning toner left on the photoconductor 61, which is not transferred onto the intermediate transfer belt 51. The image forming units 60Y, 60M, 60C, and 60K all have the same structure.

Next, the operation of the image formation is described. The charger 62 charges uniformly the surface of the photoconductor 61. On the photoconductor 61 uniformly charged, a latent image is formed with the light emitted from the laser optical section 20. The developing device 63 supplies the photoconductor 61 with toner and a toner image is formed on the photoconductor 61. The toner image formed on the photoconductor 61 with the toner supplied by the developing device 63 is transferred onto the intermediate transfer belt 51 by the transfer roller 55.

Further, the recording medium P picked up by the pickup roller 12 from the paper cassette 11 is conveyed by a plurality of conveyance rollers 82. The toner on the intermediate transfer belt 51 is transferred onto the recording medium P, when the recording medium P reached a position of the transfer roller 55. The recording medium P onto which the toner image is transferred is conveyed further. Then, the toner image is fixed onto the recording medium P by the fixing apparatus 70, and then the recording medium P with the fixed toner image is discharged to the paper discharging tray 84.

Next, components of the toner used in the following embodiments are described. The toner used in the embodiments contains at least a coloring agent and a binder resin. The coloring agent refers to a compound or a composition for the toner to have a color.

The toner used herein can be prepared in such a method as disclosed in the Japanese Patent Application Publication No. 2011-138132. Like ordinary toners, decolorizable toner is mixed with a carrier to form a developer, which is stored in, for example, the developing device 63 of the image forming apparatus 1 shown in FIG. 1. The developer or the toner may also be stored in another container and fed to the developing device when the image forming apparatus is initially started up.

With regard to the configuration of the image forming unit 60, as in a case of image forming with ordinary toner, the charger 62, an exposure device, a developing device 63, a transfer roller 64, and a transfer member (the intermediate transfer belt 51) are arranged around the photoconductor 61. The surface of the photoconductor 61 is uniformly charged by the charger 62, irradiated with light corresponding to image information by the exposure device to form an electrostatic latent image. Then, the toner is fed from the developing device 6 and a toner image is developed, and the toner image is transferred onto the recording medium P from the surface of the photoconductor 61 through the intermediate transfer belt 51.

A DC or an AC+DC development bias may be applied to the developing roller of the developing device 63. Further, a proper transfer bias may also be applied to the transfer roller 64. A proper transfer bias may also be applied to the transfer device 55. Residual non-transferred toner that may be left on the photoconductor 61 may be removed from the surface of the photoconductor by a cleaning member and scraped or collected in the developing device. Such a cleaning member may not provided. Further, the electrostatic latent image left on the photoconductor may be removed by a charge removing device. A fixing apparatus is disposed downstream with respect to the transfer area in a conveying direction.

The fixing apparatus will be described in detail below. The heating source may be a halogen lamp or an induction heating apparatus. As stated below, an elastic layer having a thickness of 50-1000 um, preferably, 100-400 um, is disposed on the surface of a roller or a belt such that the elastic layer is adjacent to a toner image.

The elastic layer may be made from silicone rubber, foamed silicone rubber, fluororubber (FKM, FEPMM, FFKM), urethane rubber, foamed urethane rubber, ethylene-propylene rubber, chlorosulfonated polyethylene rubber, foamed polyethylene resin, foamed polyolefin resin, nitrile rubber, hydroxylation nitrile rubber, foamed nitrile rubber, ethylene propylene rubber, chloroprene rubber, acrylic rubber, butyl rubber, and epichlorohydrin rubber.

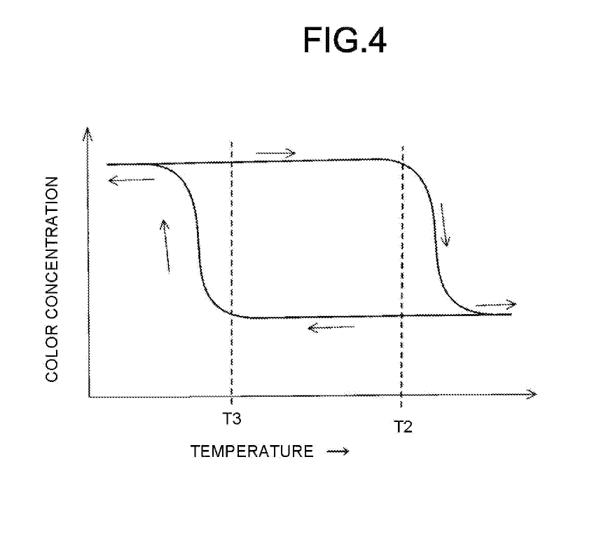

Next, a relationship between a fixing temperature and a decolorizing temperature in the fixing apparatus according to embodiments is described with reference to FIG. 3 and FIG. 4. The toner used herein containing pigment, a coloring agent, and a decolorizing agent. The toner has a color and the color is decolorized at a temperature higher than a given temperature or by a solvent.

FIG. 3 is a graph illustrating a relationship between a fixing rate of the toner in the fixing apparatus and a temperature of the toner. The abscissa of FIG. 3 represents temperature (degrees centigrade), and the ordinate of FIG. 3 represents fixing rate. The toner transferred to a recording medium is not completely fixed onto the recording medium unless temperature of the toner is higher than a fixed temperature T1. The lower limit of a fixing temperature T1 is, for example, 70 degrees centigrade.

FIG. 4 shows a relationship between the temperature and the coloring hysteresis characteristic of a coloring agent. The abscissa of FIG. 4 represents temperature (degrees centigrade), and the ordinate of FIG. 4 represents color concentration. The color concentration of the coloring agent having a color at normal temperature is sharply decreased at a decolorizing starting temperature T2 and is not recovered if the temperature is not reduced to a color development temperature T3. The decolorizing starting temperature T2 is, for example, 100 degrees centigrade, and the color development temperature T3 is, for example, −10 degrees centigrade.

To fix a toner having such characteristics reliably onto a recording medium with the fixing apparatus, the toner must be fixed at a temperature higher than the lower limit of a fixing temperature T1 and lower than the decolorizing starting temperature T2. As toner on the recording medium has a certain thickness, temperature of the top surface of the toner that is in contact with a heating member is higher and temperature of the bottom surface of the toner that is in contact with the recording medium is lower. Thus, to fix the toner reliably, the temperature difference between the lower limit of a fixing temperature T1 and the decolorizing starting temperature T2 is preferably as great as possible.

### First Embodiment

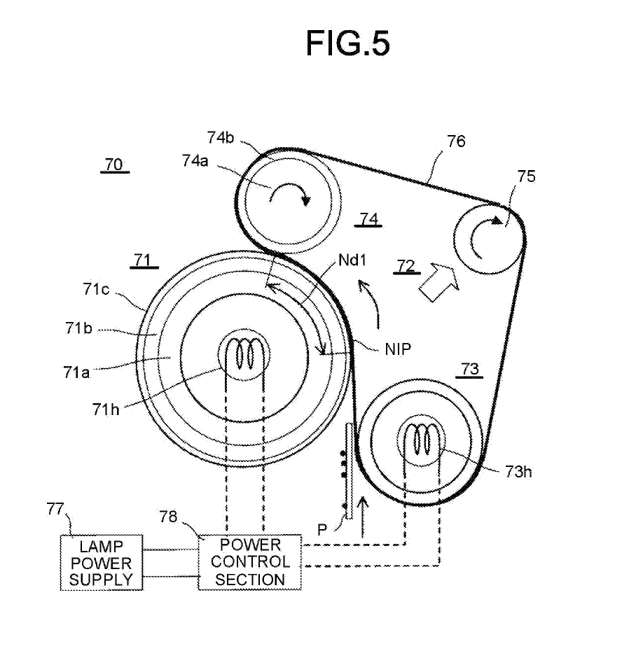

Next, a fixing apparatus 70 according to a first embodiment is described below with reference to FIG. 5. The fixing apparatus consists substantially of a heating roller 71 and a pressure-side mechanism 72. A halogen lamp 71h is disposed at the center of the heating roller 71 as a heating source. An aluminum tube 71a is disposed outside the halogen lamp 71h as a metal tube. A silicone rubber layer 71b having a lower thermal conductivity than aluminum is disposed on the surface of the aluminum tube 71a, and a fluororesin layer 71c is disposed at the outmost surface of the heating roller 71. That is, the aluminum tube 71a is arranged outside the halogen lamp 71h, and the silicone rubber layer 71b having a lower thermal conductivity and a better heat retaining property than the metal material is arranged outside the aluminum tube 71a. The pressure-side mechanism 72 consists of a pressure-side heating roller 73, a pressure roller 74, a tension roller 75, and an endless pressure belt 76.

A halogen lamp 73h is arranged in the pressure-side heating roller 73 to heat the pressure belt 76.

The pressure roller 74 has a silicone rubber layer 74b on the surface of an iron core 74a and presses the heating roller 71 with the pressure belt 76 therebetween. The pressure-side heating roller 73, the pressure roller 74, and the tension roller 75 are arranged in the endless pressure belt 76, and a tension is applied to the endless pressure belt 76 by the tension roller 75.

Further, a part of the endless pressure belt 76 between the pressure-side heating roller 73 and the pressure roller 74 is in contact with the heating roller 71 by a given distance, and a pressure is applied to the side of the heating roller 71. That is, the pressure-side mechanism 72 is opposite to the heating roller 71, and one part of the pressure-side mechanism 72 has a function of pressing the heating roller 71.

Further, the fixing apparatus 70 comprises a lamp power supply 77 which supplies power to the halogen lamps 72h and 71h and a power control section 78 which controls the power to be supplied from the lamp power supply 77 to the halogen lamps 72h and 71h in order to regulate the surface temperature of the heating roller 71 and the pressure-side heating roller 73. The power control section 78 constitutes a temperature control section capable of carrying out a temperature control between a fixing temperature at which a toner image is fixed onto a recording medium and a decolorizing temperature at which the color of the toner image is decolorized.

The heating roller 71 has a silicone rubber layer 71b having a thickness of 200 μm on the surface of the aluminum tube 71a having a wall thickness of 1 mm and an outer diameter of 45 mm and a fluororesin layer 71c having a thickness of 30 μm serving as a protective layer on the outermost surface of the heating roller 71. The heating roller 71 is heated from inside by the halogen lamp 71h having, for example, 700 W of power dissipation.

The pressure roller 74 has a silicone rubber layer 74b having a thickness of 2 mm on the surface of the iron core 74a having a diameter of 20 mm and is urged towards the center part of the heating roller 71. The pressure-side heating roller 73 consisting of an aluminum tube having a wall thickness of 1 mm is heated from inside by the halogen lamp 73h having, for example, 300 W of power dissipation.

Further, to make the configuration understood more easily, the size of each roller shown in FIG. 5 is not presented in proportion to the aforementioned size.

The fixing belt 76 is an endless belt having a diameter of 48 mm, which has a silicone rubber elastic layer having a thickness of 150 μm and a fluororesin layer having a thickness of 30 μm laminated on a PI layer of which thickness is 70 μm. The heating roller 72, the pressure-side heating roller 73 and the tension roller 75 are disposed in a space inside the fixing belt 76, and the tension of the fixing belt 76 is maintained by the tension roller 75 being urged outward against the fixing belt 76.

Further, an external surface of the pressure belt 76 is pressed against the heating roller 71, and thereby a nip section NIP having a wide fixation region is formed by the heating roller 71 and the pressure belt 76. The nip section NIP is formed in a region where the heating roller 71 is in contact with the pressure belt 76, and has a distance Nd1 extending from a position where the heating roller 71 starts to contact the pressure belt 76 in the rotational direction to a position where the contact of the heating roller 71 with the pressure roller 74 ends. The toner on the recording medium P is heated and fixed onto the recording medium P at the nip section NIP. When the nip section NIP is large, the temperature difference between temperature at a front surface of the recording medium having a toner image and temperature at a rear surface of the recording medium is small, which is preferable from the viewpoint of temperature control. Thus, the endless press belt 76 deforming along the outer periphery of the heating roller 71 is adopted in the first embodiment.

In accordance with the rotation of the heating roller 71 and the pressure-side heating roller 73, the press belt 76 rotationally moves in a direction along with a rotational direction of the pressure roller 74. The recording medium with the transferred toner is conveyed into the nip section NIP between the heating roller 71 and the pressure belt 76 such that the toner contacts the heating roller 71. As the nip section NIP can have a length of 20 mm or so, the toner can be heated within about 200 msec even at a process speed of 100 mm/sec.

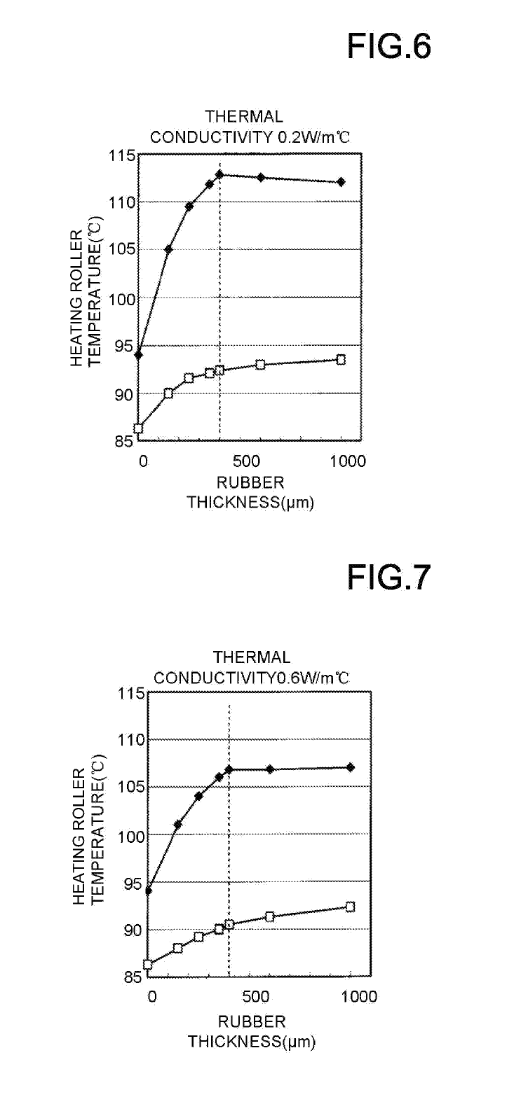

With the thickness of a silicone rubber layer, which is arranged on the heating roller 71 of the fixing apparatus 70, being changed from 0 to 1 mm, a maximum temperature of the toner layer when the recording medium on which the toner image is transferred passes through the heating roller 71 is calculated employing simulation. The result is shown in FIG. 6 and FIG. 7.

In FIG. 6 and FIG. 7, the abscissa represents the thickness (um) of the rubber of the heating roller 71, and the ordinate represents the heating roller 71 temperature (degrees centigrade). FIG. 6 shows a case in which a silicone rubber having a thermal conductivity of 0.2 W/mC used for an elastic layer, and FIG. 7 shows a case in which a silicone rubber having a thermal conductivity of 0.6 W/mC is used. A diamond ♦ represents an upper limit while a square □ represents a lower limit.

The upper limit represents a temperature of a heating roller 71 that causes the temperature of the upper surface of toner layer (a surface in contact with the heating roller 71) to reach 94 degrees centigrade, which is a temperature above which the toner is decolorized. Also, the lower limit represents a temperature of a heating unit that causes the temperature of the lower surface (a surface in contact with a recording medium) to reach 86 degrees centigrade, which is a temperature above which the toner is reliably fixed onto the recording medium. In the simulation, the temperature of the heating roller 71 and the pressure belt 76 are controlled such that the surface of the heating roller 71 and the surface of the pressure belt 76 have the same temperature, and a recording medium (a sheet having a thickness of about 100 μm) having the unfixed toner layer (a toner particle layer having a thickness of 20 μm and containing about 60% air) is conveyed through the nip. The temperatures of the top surface and the bottom surface of the toner layer at the end point of the nip section NIP are calculated through the simulation, and then the temperatures of the heating roller 71 corresponding to the upper limit condition and the lower limit condition are obtained.

Here, the temperature at which the toner is decolorized and the temperature at which the toner is reliably fixed are obtained from an experiment, but these temperatures are not limited to the specific values.

It is preferable that a difference between the upper limit temperature and the lower limit temperature is greater. In the absence of such a rubber layer, the difference between the upper limit temperature and the lower limit temperature is about 8 degrees centigrade.

With respect to this, as shown in FIG. 7, by disposing a rubber layer having a thermal conductivity of 0.6 W/mC and a thickness of 400 um, the difference between the upper limit temperature and the lower limit temperature is increased to about 16 degrees centigrade. On the other hand, as shown in FIG. 6, by disposing a rubber layer having a thermal conductivity of 0.2 W/mC and a thickness of 400 μm, the difference between the upper limit temperature and the lower limit temperature is increased to about 20 degrees centigrade.

When a rubber layer is thinner than 400 μm or so, regardless of the thermal conductivity thereof, the difference between the upper limit temperature and the lower limit temperature increases in association with the thickness of the rubber layer, compared with a case where no rubber layer is disposed. However, when the thickness of the rubber layer is above 400 μm, the difference between the upper limit temperature and the lower limit temperature is almost unchanged or decreased.

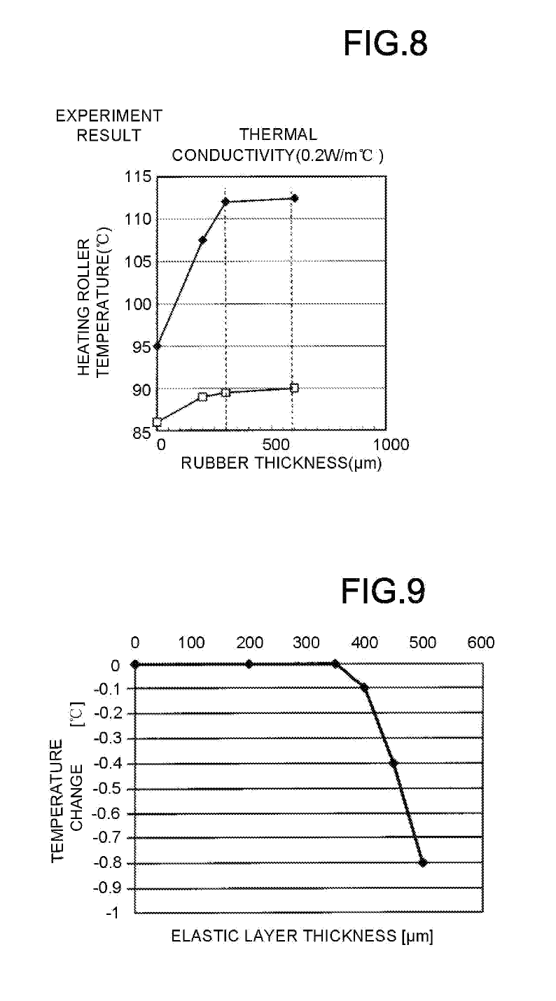

Further, using rubber having a thermal conductivity of 0.2 W/mC, four types of fixing rollers having a thickness of 0, 200 μm, 300 μm and 600 μm are prepared, and the result of experiments carried out with the fixing rollers is shown in FIG. 8. The temperature of the surface of the fixing roller at a point right before the nip is measured using a thermo viewer while an unfixed image formed with decolorizable toner is conveyed through the fixing apparatus. Temperature at which an image reflection density decreases by 20% with respect to an image reflection density without image erasing is set as an upper limit temperature, and temperature at which a residual rate of an image (image density after being rubbed/image density before being rubbed) rubbed by a fastness tester is 75% is set as a lower limit temperature.

The fixing roller having a thickness of 300 μm and a fixing roller having a thickness of 600 μm almost present the same calculation result, and also it was found that wider difference between the upper limit temperature to the lower limit temperature are obtained compared to the difference obtained from the calculation due to the stable increase of the lower limit temperature according to the calculated value. The toner layer is considered to be fixed at a lower temperature because the rubber layer having elasticity can closely contact a toner layer and more significant heat conduction is achieved.

A thickness greater than 100 μm is considered to be sufficient for the elastic layer based on the results shown in FIG. 6 to FIG. 8.

As stated above, in the conventional situation in which no rubber layer is disposed on a heating surface in contact with toner, the range from the upper limit to the lower limit is small. As a consequence, it is extremely difficult to maintain a temperature at which a fixation can be performed and a decolorizing does not occur while a temperature of a fixing apparatus decreases due to the continuous paper passage or rises at outside a paper area due to the continuous printing of small-sized papers.

With respect to this, by disposing an elastic layer having a low thermal conductivity on a heating surface that contacts toner, a fixation is carried out more stably without decolorizing. That is, the range of a fixing temperature can be widened according to an embodiment of the present invention.

This is because the slow heat transfer achieved with a rubber layer having a lower thermal conductivity than metals can achieve a uniform temperature distribution in the orthogonal direction of the paper surface of a recording medium. A thick toner layer is affixed when a color printing is carried out on the recording medium.

A temperature distribution in the depth direction of a toner layer becomes wider as the toner layer becomes thicker. Thus, the temperature in the middle part of the toner layer may be low although the surface temperature of the toner layer is high. However, even when the temperature in the middle part increased to the fixing temperature, it is preferable that the surface temperature does not reach a decolorizing temperature. That means that the wider the range from the upper limit temperature to the lower limit temperature of the fixing apparatus leads to the more stable fixation.

Here, a preferable upper limit for the thickness of the elastic layer arranged on the surface of a roller is described. By disposing an elastic layer on the metal tube, the temperature rise of the upper part of the toner layer contacting the elastic later is slowed down, and a visible image can be formed with decolorizable toner when the temperature of the upper part of the toner layer does not reach the decolorizing temperature even if the temperature of the lower part of the toner layer serving as a contact part that is in contact with a transfer medium is increased to a fixable temperature.

However, in accordance with the miniaturization of apparatuses, the diameter of a roller tends to be small and the circumferential length in the rotation direction thereof greatly decreases compared to a length of a sheet in the conveying direction. For example, in the case of a heating roller having a diameter of 50 mm, to enable the passing of a sheet having a size of A3, one point of the heating roller contacting the front end of the paper contacts the transfer paper for three times (many times) in a short time. The temperature of the surface part of the heating roller after it has decreased due to the contact with the toner layer must be recovered to the initially set temperature within the time the heating roller makes one revolution through the nip section and returns to the starting point of the nip section. If the temperature is not recovered after the heating roller makes one revolution, in three times of contact, the surface temperature of the heating roller becomes lower while rotating, leading to a risk that the toner layer cannot be heated to an expected temperature. It is likely that the lower the thermal conductivity of a member is, the harder it is to increase the temperature of the member.

In the case of an ordinary non-decolorizable toner, a upper limit temperature can be set to temperature at which no high temperature offset generates, and by designing the molecular weight of a binder resin the upper limit temperature can be set higher. Thus, by increasing the temperature of the heating roller at a region where the front end of a paper enters the nip section to a certain extent, the fixation at the rear end of the paper can be reliably achieved even if the temperature of the heating roller is decreased slightly.

However, as to the decolorizable toner used in embodiments described herein, as the range from the lower limit of fixing temperature to the upper limit of a temperature at which no decolorizing is achievable is greatly narrowed than that of ordinary toner, the temperature difference of the heating rollers at the front end of a paper and at the rear end of the paper leads to a risk of the occurrence of decolorizing during a fixation.

As the elastic layer becomes thicker, it takes longer time to recover to a given temperature within one revolution. Thus, there is a preferable upper limit for the thickness of the elastic layer.

In the fixing apparatus having the structure shown in FIG. 5, the calculation result of a thermal simulation obtained when the diameter of the heating roller 71 is 50 mm, the width of the nip section NIP is 20 mm and the process speed is 135 mm/sec is shown in FIG. 9. The abscissa shown in FIG. 9 represents the thickness (μm) of an elastic layer, and the ordinate represents the temperature change of a region of the elastic layer in the second revolution with respect to the first revolution at the starting point of the nip section. That is, it can be known from FIG. 9 that the temperature decreases sharply at about 400 μm.

Thus, it is considered that the preferable upper limit on the thickness of the elastic layer (rubber layer) is about 400 μm. If the thickness of the elastic layer is below 400 μm, the temperature of the heating roller before the second contact is substantially recovered to the temperature before the first contact.

On the other hand, when a paper passage experiment on A4 paper on the condition seen in FIG. 9 is performed, no fixing failure occurs even if 50 pages are printed continuously with the thickness of rubber layer is 0 μm, 200 μm, and 300 μm. However, in a case where a thickness the rubber layer is 500 μm or larger, a fixing failure occurs when the tenth page is printed. Further, the color of the first page is decolorized when temperature is set to be higher than the initially set temperature. Thus, it is impossible to achieve a fixing state and a non-decolorizing state during a continuous printing.

Even If the toner layer is set capable of being heated at the nip section NIP to a temperature higher than the fixing temperature and lower than the decolorizing temperature with other sizes of sheets and process speeds adoptable to the image forming apparatus, the result that a thickness of 400 μm for the elastic layer is the upper limit of thickness for maintaining the temperature of the heating roller can be confirmed through calculation.

According to the embodiment, as the soft pressure belt 76 contacts the heating roller 71, the nip section is widened, and therefore a stable fixation can be achieved even when the toner layer is thick for the purpose of, for example, a color printing. Especially, when the diameter of the heating roller 71 is large, the distance Nd1 of the nip section NIP can be increased to perform a stable fixation.

It can be appreciated that a thickness range from about 100 μm to about 400 μm is preferable for the elastic layer based on the aforementioned result.

The pressure-side mechanism 72, although provided with a pressure-side heating roller 73 in the first embodiment, is not necessarily provided with the pressure-side heating roller 73 but may be provided with a roller equivalent to the pressure roller 74.

In the first embodiment, the pressure-side heating roller 73 heats the endless pressure belt 76 so that the endless pressure belt 76 may deprive little heat from the recording medium P.

### Second Embodiment

A fixing apparatus having a pressure belt is described in the first embodiment above. In addition, the present invention is also applicable to a fixing apparatus in which a heating roller is pressed against a pressure roller.

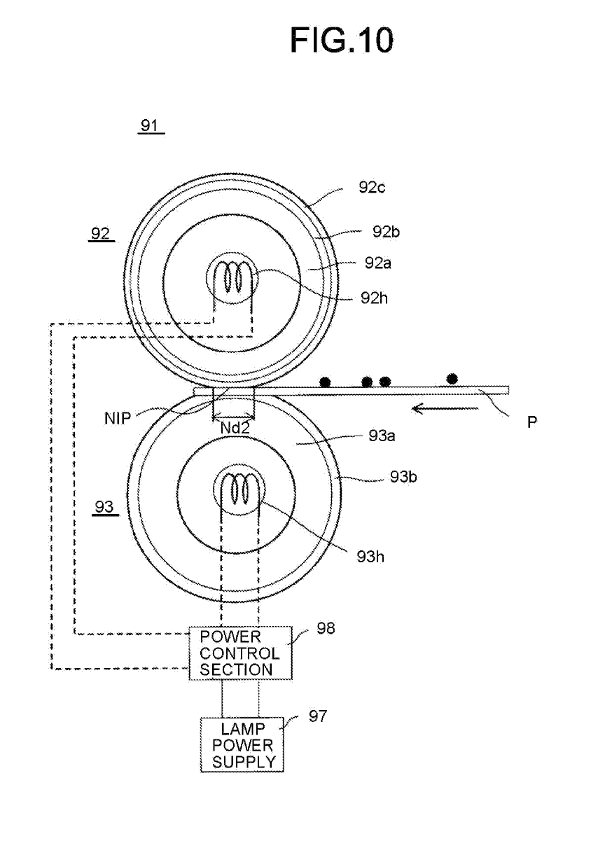

Next, a fixing apparatus according to a second embodiment is described below. FIG. 10 shows a sectional view illustrating the structure of a fixing apparatus according to the second embodiment. A fixing apparatus 91 comprises a tubular heating roller 92 that contacts a toner image on a recording medium and a tubular pressure roller 93 pushed by the heating roller 92 from the back side of the recording medium. Halogen lamps 92h and 93h are disposed in the heating roller 92 and the pressure roller 93, respectively. The halogen lamps 92h and 93h are connected with a lamp power supply 97 which supplies power to the lamps and a power control section 98 which controls the power supply from the lamp power supply 97 to the halogen lamps 92h and 93h to change surface temperatures of the heating roller 92 and the pressure roller 93. The power control section 98 constitutes a temperature control section capable of carrying out a temperature control between a fixing temperature at which the toner image is fixed on a recording medium and a decolorizing temperature at which the color of the toner image is decolorized.

The heating roller 92 is formed into the shape of a roller of which outer diameter is 80 mm and which has a silicone rubber layer 92b having a thickness of 200 μm and a PFA layer 92c having a thickness of 30 μm on the surface of an aluminum tube 92a having an aluminum-made wall thickness of 1.5 mm. The heating roller 92 is heated from inside by the 500 W halogen lamp 92h.

The pressure roller 93, which has a silicone sponge layer 93b having a thickness of 2 mm on the surface of a SUS tube 93a having a wall thickness of 1 mm, is heated from inside by the 400 W halogen lamp 93h.

The heating roller 92 and pressure roller 93 are pressed by each other to be in contact with each other, thereby forming a nip section NIP having a width Nd2 of about 6 mm.

By disposing a silicone rubber layer serving as an elastic material for the outer peripheral surface, a certain degree of nip section NIP may be formed on the outer peripheral surface. Thus, the present invention has an advantage of a small temperature difference between the temperature of the surface of a recording medium formed with a toner image and the temperature of the back side of the recording medium.

By the heating roller 92 and the pressure roller 93 rotating at a speed of 30 mm/sec, the recording medium P to be conveyed through is heated and pressed in the nip section for about 200 msec to make the toner on the recording medium to be heated substantially uniformly.

In the embodiment, as the elastic layer arranged on the tube 93a of the pressure roller 93 is made from sponge which is softer than rubber, there is an advantage of forming a longer nip section.

According to the above embodiments, by a recording medium with a transferred toner image being conveyed through a fixing apparatus, the toner image can be fixed onto the recording medium without a practical problem and decolorizing of the toner.

Although the halogen lamps are used as heating sources in the heating roller and the fixing roller according to the above embodiments, other heating sources are applicable as well. The heating source can be any heating source that is capable of changing temperature at the surface of the fixing roller between the fixing temperature and the decolorizing temperature.

According to the above embodiments, an image forming apparatus is provided which performs a fixation of decolorizable toner stably without decolorizing the color of the decolorizable toner.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A fixing apparatus, comprising:
a heating unit configured to heat a sheet having a layer of decolorizable toner applied thereon and including:
a roll member,
an elastic layer formed on an outer periphery of the roll member, and
a heat generating unit;
a pressing unit configured to press the sheet towards the heating unit; and
a control unit configured to control the heat generating unit, such that a first temperature at a portion of a first surface of the decolorizable toner layer contacting the heating unit is lower than a first predetermined temperature at which the decolorizable toner is decolorized, and a second temperature at a portion of the second surface of the decolorizable toner layer opposite to the first surface is higher than a second predetermined temperature at which the decolorizable toner is fixed onto the sheet.

2. The fixing apparatus according to claim 1, wherein a nip is formed between the pressing unit and a portion of the heating unit pressed by the pressing unit, and the portion of the first surface and the portion of the second surface are located at an end of the nip in a sheet conveying direction.

3. The fixing apparatus according to claim 1, wherein the elastic layer is a silicone rubber layer.

4. The fixing apparatus according to claim 1, wherein a thickness of the elastic layer is equal to or greater than 100 μm and equal or smaller than 400 μm.

5. The fixing apparatus according to claim 1, wherein the pressing unit includes a belt pressing the sheet towards the heating unit.

6. The fixing apparatus according to claim 4, wherein the pressing unit further includes a heat generating unit, and the control unit is configured to control the heat generating unit of the pressing unit to generate heat.

7. The fixing apparatus according to claim 1, wherein the pressing unit includes a roll member pressing the sheet towards the heating unit.

8. An image forming apparatus, comprising:
a developing unit configured to develop an toner image by supplying decolorizable toner to an electrostatic latent image formed on a surface of a photoconductor;
a transfer unit configured to transfer the toner image of the decolorizable toner on the photoconductor to a sheet; and
a fixing unit configured to fix the toner image onto the sheet and including:
a heating unit configured to heat a sheet having a layer of the decolorizable toner applied thereon and including:
a roll member,
an elastic layer formed on an outer periphery of the roll member, and
a heat generating unit,
a pressing unit configured to press the sheet towards the heating unit; and
a control unit configured to control the heat generating unit, such that a first temperature at a portion of a first surface of the decolorizable toner layer contacting the heating unit is lower than a first predetermined temperature at which the decolorizable toner is decolorized, and a second temperature at a portion of the second surface of the decolorizable toner layer opposite to the first surface is higher than a second predetermined temperature at which the decolorizable toner is fixed onto the sheet.

9. The image forming apparatus according to claim 8, wherein a nip is formed between the pressing unit and a portion of the heating unit pressed by the pressing unit, and the portion of the first surface and the portion of the second surface are located at an end of the nip in a sheet conveying direction.

10. The image forming apparatus according to claim 8, wherein the elastic layer is a silicone rubber layer.

11. The image forming apparatus according to claim 8, wherein a thickness of the elastic layer is equal to or greater than 100 μm and equal or smaller than 400 μm.

12. The image forming apparatus according to claim 8, wherein the pressing unit includes a belt pressing the sheet towards the heating unit.

13. The image forming apparatus according to claim 12, wherein the pressing unit further includes a heat generating unit, and the control unit is configured to control the heat generating unit of the pressing unit to generate heat.

14. The image forming apparatus according to claim 8, wherein the pressing unit includes a roll member pressing the sheet towards the heating unit.

15. A method for operating a fixing apparatus including:
a heating unit configured to heat a sheet having a layer of decolorizable toner applied thereon and including:
a roll member,
an elastic layer formed on an outer periphery of the roll member, and
a heat generating unit, and
a pressing unit configured to press the sheet towards the heating unit,
the method comprising:
controlling the heat generating unit, such that a first temperature at a portion of a first surface of the decolorizable toner layer contacting the heating unit is lower than a first predetermined temperature at which the decolorizable toner is decolorized, and a second temperature at a portion of the second surface of the decolorizable toner layer opposite to the first surface is higher than a second predetermined temperature at which the decolorizable toner is fixed onto the sheet.

16. The method according to claim 15, wherein a nip is formed between the pressing unit and a portion of the heating unit pressed by the pressing unit, and the portion of the first surface and the portion of the second surface are located at an end of the nip in a sheet conveying direction.

17. The method according to claim 15, wherein the elastic layer is a silicone rubber layer.

18. The method according to claim 15, wherein a thickness of the elastic layer is equal to or greater than 100 μm and equal or smaller than 400 μm.

19. The method according to claim 15, wherein the pressing unit includes a belt pressing the sheet towards the heating unit.

20. The method according to claim 19, wherein the pressing unit further includes a heat generating unit, and the method further comprising: controlling the heat generating unit of the pressing unit to generate heat.
